(19) United States
(12) Patent Application Publication
(10) Pub. No.: US 2026/0015179 A1
(43) Pub. Date: Jan. 15, 2026

(54) CONVEYOR DEVICE

(71) Applicant: Hitachi Industry & Control Solutions, Ltd., Tokyo (JP)

(72) Inventors: Kosuke TOMOBE, Tokyo (JP); Yukihiro YAMANAKA, Tokyo (JP); Sho SAIMARU, Tokyo (JP); Kunitaka ASANO, Tokyo (JP); Michio MIMURA, Tokyo (JP)

(73) Assignee: Hitachi Industry & Control Solutions, Ltd., Tokyo (JP)

(21) Appl. No.: 18/993,747

(22) PCT Filed: Jun. 21, 2023
(86) PCT No.: PCT/JP2023/022927

§ 371 Date: Jan. 13, 2025

(30) Foreign Application Priority Data
Aug. 2, 2022 (JP) 2022-123558

(51) Int. Cl. B65G 23/02

(52) U.S. Cl. CPC B65G 23/02; B65G 2201/0235

(57) ABSTRACT

A conveyor device used in manufacturing equipment to convey various types of containers, such as an ampule, varying in diameter includes: a lower belt conveying element that supports a body on an upstream side and a bottom surface of the container to be conveyed; and an upper belt conveying element that supports the body on a downstream side of the container to be conveyed, wherein a distance between the lower belt conveying element and upper belt conveying element, which are respectively on a front side and a rear side of each of the containers, is adjusted to convey the containers varying in diameter.

### TECHNICAL FIELD

The present invention relates to a conveyor device.

### BACKGROUND ART

Patent Literature 1 describes a conveyor device that is capable of conveying containers such as syringes, ampules, and vials, without replacing conveying parts even when the containers vary in diameter from batch to batch. Patent Literature 1 also describes that “Grip arms vertically arranged in multiple steps stably hold the containers varying in diameter and convey them at high speed”.

### PRIOR ART LITERATURE

### Patent Literature

Patent Literature 1: Japanese patent application publication No. 2017-001888

### SUMMARY OF THE INVENTION

### Problem to be Solved

Patent Literature 1 discloses a mechanism that is configured to stably hold containers varying in diameter and convey them at high speed. However, the conveyor device described in Patent Literature 1 has a mechanism that is configured to convey containers along a circumferential path. This mechanism has an issue that a plurality of devices that hold and convey containers must be provided when a conveyed-from point is distant from a conveyed-to point. The present invention is devised to deal with such an issue and aims to provide a conveyor device capable of conveying objects even when a conveyed-from point is distant from a conveyed-to point.

### Means to Solve the Problem

To solve the above issue, a conveyor device of the present invention is used in manufacturing equipment to convey various types of containers, such as an ampule, varying in diameter. The conveyor device comprises: a lower belt conveying element that supports a body on an upstream side and a bottom surface of each of the containers to be conveyed; and an upper belt conveying element that supports the body on a downstream side of each of the containers to be conveyed. A distance between the lower belt conveying element and upper belt conveying element, which are respectively on a front side and a rear side of each of the containers, is adjusted to allow for conveying the containers varying in diameter.

### Advantageous Effects of the Invention

The present invention provides a conveyor device that conveys objects even when a conveyed-from point is distant from a conveyed-to point.

### BRIEF DESCRIPTION OF DRAWINGS

FIG. 1 is a plan view of a conveyor belt of an embodiment, an inspection device, according to the present invention;

FIG. 2A is a perspective view from a direction I in FIG. 1;

FIG. 2B is an enlarged view of an area II in FIG. 2A;

FIG. 2C is a top view of components in FIG. 2B, as viewed from a direction III;

FIG. 3 is a cross-sectional view of a driving pulley at a driving shaft in FIG. 1, taken along a line IV-IV in FIG. 1;

FIG. 4A is a top view schematically showing an upper pulley, a lower pulley, and a type change plate that convey a container having a small diameter;

FIG. 4B is a top view schematically showing the upper pulley, lower pulley, and type change plate that convey a container having a large diameter;

FIG. 5 is an exploded perspective view of the upper pulley, lower pulley, and type change plate;

FIG. 6 is a perspective view of the upper pulley, lower pulley, and type change plate being assembled;

FIG. 7 is a cross-sectional view of a driven pulley for the conveyor belt, taken along a line V-V in FIG. 1; and

FIG. 8 is an exploded perspective view of an upper pulley, a lower pulley, and a type change plate of a modification.

### EMBODIMENTS OF THE INVENTION

Embodiments of the present invention are described below with reference to drawings as appropriate. The present invention provides a conveyor device that stably holds containers, such as syringes, ampules, and vials, which vary in diameter and linearly conveys them. Hereinafter, the embodiments are described with reference to drawings.

### First Embodiment

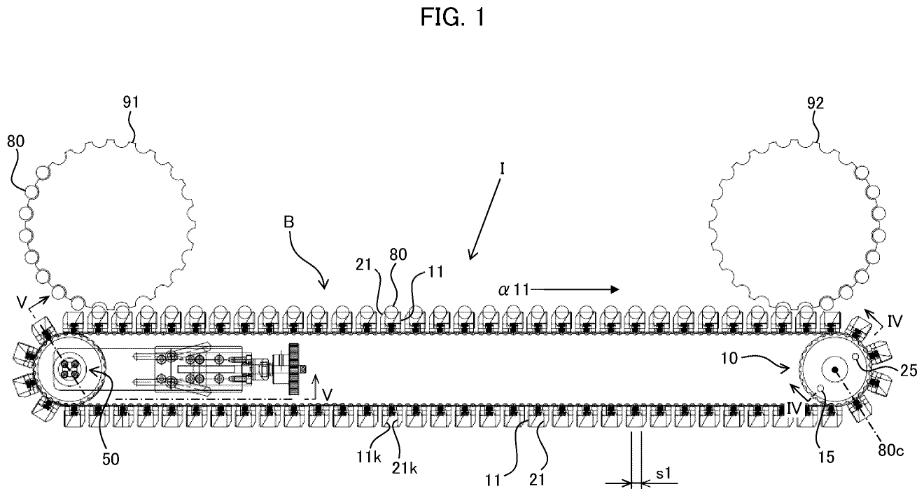

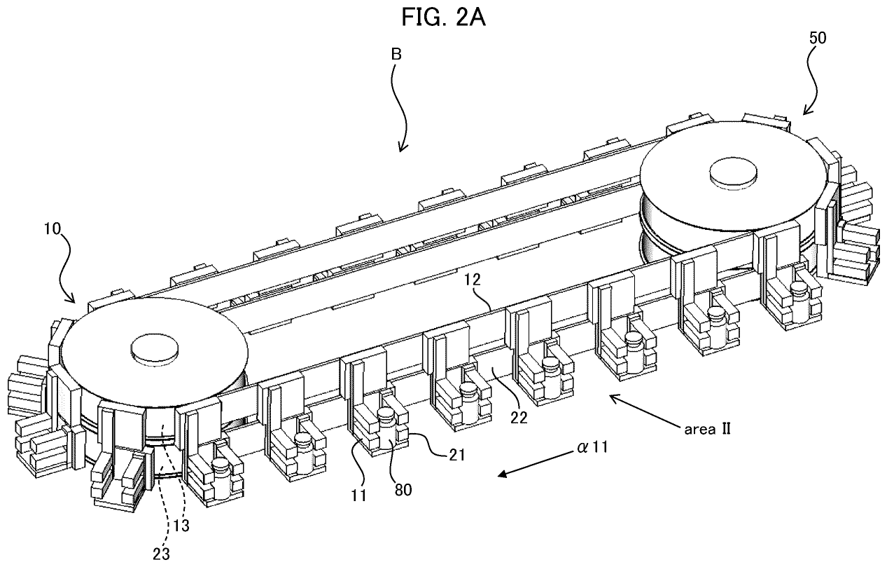

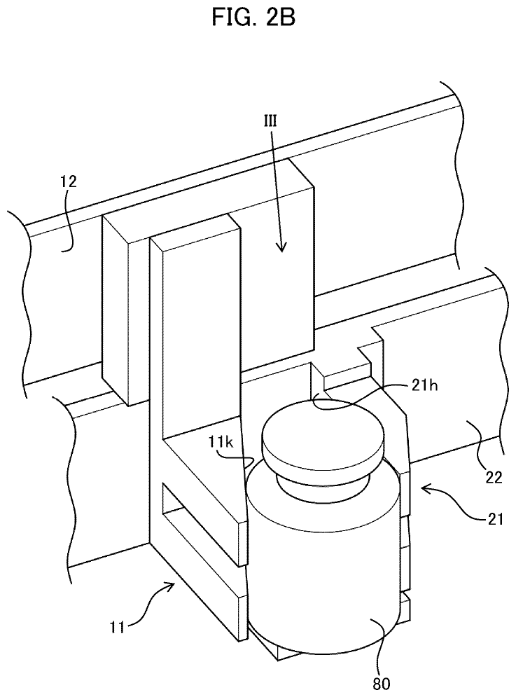

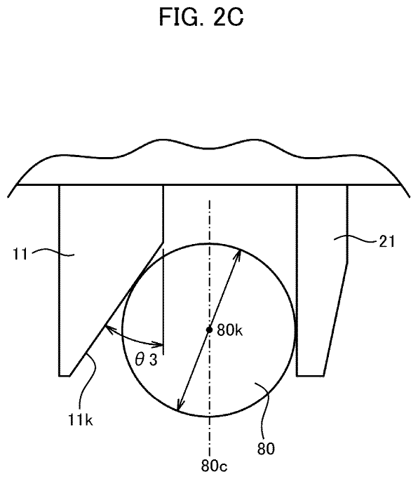

FIG. 1 is a plan view of a conveyor belt B of an embodiment, an inspection device, according to the present invention. FIG. 2A is a perspective view from a direction I in FIG. 1. FIG. 2B is an enlarged view of an area II in FIG. 2A. FIG. 2C is a top view of components in FIG. 2B, as viewed from a direction III.

The conveyor belt B of the embodiment shown in FIG. 1 has a function to sequentially transfer containers 80 held by an upstream star wheel 91 in the inspection device of manufacturing equipment, to a downstream star wheel 92. The conveyor belt B linearly connects the upstream star wheel 91 with the downstream star wheel 92.

The conveyor belt B shown in FIG. 2A includes a driving pulley 10, a driven pulley 50, an upper profile belt 12, and a lower profile belt 22. The upper profile belt 12 and the lower profile belt 22 are wound over the driving pully 10 and the driven pulley 50, in a vertically double-deck manner. The lower profile belt 22 is provided with a plurality of rear conveying element 21 (see FIG. 2B). The upper profile belt 12 is provided with a plurality of front conveying element 11.

As shown in FIG. 2A, the lower profile belt 22 is wound over a lower pulley 23. The upper profile belt 12 is wound over an upper pulley 13.

As shown in FIGS. 1 and 2A, the containers 80 held by the upstream star wheel 91 are conveyed, with each being held between the front conveying element 11 and the rear conveying element 21. The containers 80 are transferred to the downstream star wheel 92 (see FIG. 1) after conveyance. This structure allows for changing a relative position (phase shift) between the lower pulley 23 and the upper pulley 13, to adjust a distance between the rear conveying element 21 and the front conveying element 11, and conveys the containers 80 which vary in diameter and is held by the rear conveying element 21 and the front conveying element 11. In other words, a distance between the front conveying element 11 (first conveying element) and the rear conveying element 21 (second conveying element) is altered depending on a diameter of each container.

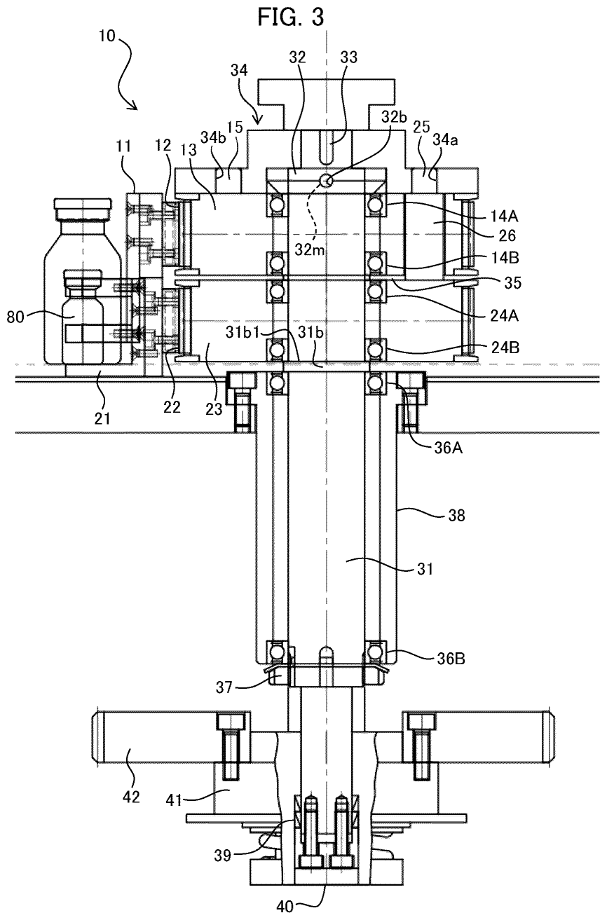

FIG. 3 is a cross-sectional view of the driving pulley 10 at a driving shaft in FIG. 1, taken along a line IV-IV in FIG. 1. The driving pulley 10 includes the lower pulley 23, the upper pulley 13, and a type change plate 34.

As shown in FIGS. 2A and 2B, the rear conveying element 21 that holds the container 80 is provided on the lower profile belt 22 wound over the lower pulley 23. The front conveying element 11 that holds the container 80 is provided on the upper profile belt 12 wound over the upper pulley 13.

As shown in FIG. 2C, the front conveying element 11 shown in FIG. 1 has an inclined surface 11k that has an inclination angle of θ3 (=45 degrees) in a top view and that contacts and holds a front side (a side facing a traveling direction) of the container 80. The rear conveying element 21 has, in a top view, a non-inclined flat surface 21k that contacts and holds a rear side (a side facing opposite to the traveling direction) of the container 80. The front conveying element 11 holding the container 80 with the inclined surface 11k, at the inclination angle of θ3 (=45 degrees) in a top view, allows for a certain amount of variation in size of the container 80 when the rear conveying element 21 holds the container 80 in a different size with the non-inclined flat surface 21k.

This structure, even for the container 80 in a different size, allows the container 80 to be securely conveyed with being held by the inclined surface 11k (see FIG. 2C), at an inclination angle of θ3 (=45 degrees), of the front conveying element 11 and the non-inclined flat surface 21k of the rear conveying element 21.

### Driving Pulley 10

The type change plate 34 of the driving pulley 10 shown in FIG. 3 is a part that alters a relative angle between the lower pulley 23 over which the lower profile belt 22 is wound and the upper pulley 13 over which the upper profile belt 12 is wound, depending on a size of the conveyed container 80 (to be described in detail below). The alteration in the relative angle causes an alteration in a relative position between the lower profile belt 22 and upper profile belt 12, thereby adjusting a distance s1 between the front conveying element 11 and the rear conveying element 21. Center positions of the containers 80, each held by the front conveying element 11 and the rear conveying element 21, substantially remain unchanged. The driving pulley 10 can be applied to a general upstream star wheel 91 and a general downstream star wheel 92.

With this structure, altering the relative position (phase change) between the lower profile belt 22 and the upper profile belt 12 results in adjusting the distance s1 between the front conveying element 11 and the rear conveying element 21, thereby allowing the containers 80, which vary in container diameter 80k, to be conveyed. With this structure, the containers 80 varying in container diameter 80k (this is equal to the distance s1) is held between the front conveying element 11 and the rear conveying element 21 and conveyed. Thus, the type change plates 34 are prepared as many as the number of sizes of the containers 80 to be conveyed. For example, two sizes of the containers 80 requires two type change plates 34, or three sizes of the containers 80 requires three type change plates 34.

The upper pulley 13 shown in FIG. 3 is rotatable about a driving shaft 31 via bearings 14A, 14B. The lower pulley 23 is rotatable about the driving shaft 31 via bearings 24A, 24B. The driving shaft 31 has a thick diameter part 31b located under the lower pulley 23, to form a stepped part 31b1. The lower pulley 23 is located on the stepped part 31b1 at the thick diameter part 31b of the driving shaft 31.

A flat and circular collar 35 is inserted as a spacer between the upper pulley 13 and the lower pully 23. The upper pulley 13 is located on the collar 35. A set collar 32 in an inverted truncated cone shape is located on top of the upper pulley 13. The set collar 32 has a female screw 32n threaded therein to accept a no-head screw 32b that presses the driving shaft 31. During assembly, the set collar 32 presses the lower parts (the upper pulley 13, the collar 35, and lower pulley 23) downward. The no-head screw 32b is screwed into the female screw 32n of the set collar 32 to press the driving shaft 31 downward, thereby fixing the set collar 32 to the driving shaft 31.

Here, the set collar 32 is fixed such that pressing the lower parts (the upper pulley 13, the collar 35, and lower pulley 23) downward applies forces to the bearings 14A, 14B, 24A, 24B.

The driving shaft 31 shown in FIG. 3 is provided with the upper pulley 13 at an upper portion thereof and the lower pulley 23 under the upper pulley 13, and is supported by a bracket 38 via an upper bearing 36A and a lower bearing 37B. The driving shaft 31 has an upper portion thereof fixed to the bracket 38 via the bearing 36A located under the lower pulley 23. The driving shaft 31 has a lower portion thereof fixed to the bracket 38 via the bearing 36B and a star washer 37.

The lower portion of the driving shaft 31 is joined with a torque limiter 41 and a timing pulley 42 by a locking assembly 39 and a part 40. Loosening the locking assembly 39 to adjust an angle of the driving shaft 31 arranged with the upper pulley 13 and the lower pulley 23 allows for adjusting a timing of the container 80 being taken from the upstream star wheel 91 and taken to the downstream star wheel 92.

### Structure of Upper Pulley 13, Lower Pulley 23, and Type Change Plate 34 for Containers 80 varying in Diameter

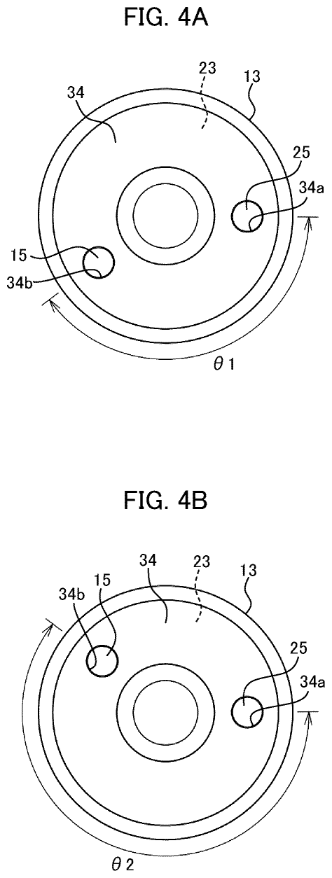

FIG. 4A is a top view schematically showing the upper pulley 13, lower pulley 23, and type change plate 34 that convey the container 80 having a small container diameter 80k (see FIG. 2C).

FIG. 4B is a top view schematically showing the upper pulley 13, lower pulley 23, and type change plate 34 that convey the container 80 having a large container diameter 80k. For the conveyor belt B that conveys the containers 80 varying in diameter, the type change plate 34 includes a base pin insertion hole 34a through which a base pin 25 is inserted and a pulley fixing pin insertion hole 34b through which a pulley fixing pin 15 is inserted. The base pin 25 integrated with the lower pulley 23 is inserted through the upper pulley 13 and the type change plate 34. As shown in FIGS. 4A and 4B, a position of the pulley fixing pin 15, which is inserted through the upper pulley 13 and the type change plate 34, is changed with reference to the base pin 25, to adjust a relative position between the lower pulley 23 and the upper pulley 13.

This changes a distance between the rear conveying element 21 and the front conveying element 11, to allow the containers 80, varying in the container diameter 80k, to be held between the rear conveying element 21 and the front conveying element 11 and conveyed. As shown in FIG. 4A, setting an angle between the lower pulley 23 and the upper pulley 13 to θ1 causes the distance s1 (see FIG. 1) between the rear conveying element 21 and the front conveying element 11 to be decreased via the lower profile belt 22 and the upper profile belt 12, to allow the container 80 having a small container diameter 80k to be held between the rear conveying element 21 and the front conveying element 11 and conveyed.

As shown in FIG. 4B, setting an angle between the lower pulley 23 and the upper pulley 13 to θ2 causes the distance s1 (see FIG. 1) between the rear conveying element 21 and the front conveying element 11 to be increased via the lower profile belt 22 and the upper profile belt 12, to allow the container 80 having a large container diameter 80k to be held between the rear conveying element 21 and the front conveying element 11 and conveyed. The structures of the upper pulley 13, the lower pulley 23, and the type change plate 34 are described in detail below.

### Structure of Upper Pulley 13, Lower Pulley 23, and Type Change Plate 34

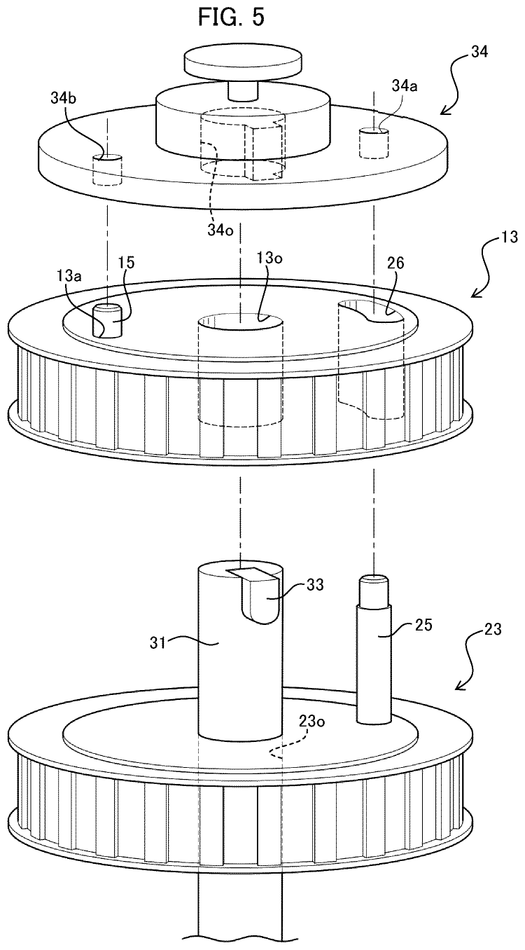

FIG. 5 is an exploded perspective view of the upper pulley 13, lower pulley 23, and type change plate 34.

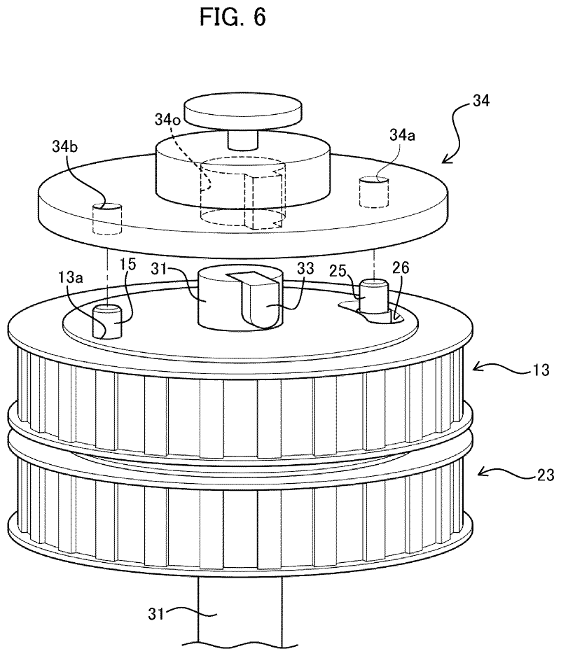

FIG. 6 is a perspective view of the upper pulley 13, lower pulley 23, and type change plate 34 being assembled. The base pin 25 to define a relative position between the upper pulley 13 and the type change plate 34 is fixed to the lower pulley 23 shown in FIG. 5 and extends upward. The lower pulley 23 is provided at a center thereof with a shaft hole 230 through which the driving shaft 31 is inserted. The upper pulley 13 is provided with a center shaft hole 130 through which the driving shaft 31 is inserted, a positioning hole 13a, and an elongated slide hole 26 in a fan shape, so as to vertically penetrate the upper pulley 13.

The pulley fixing pin 15 is inserted into the positioning hole 13a for positioning the upper pully 13 with respect to the lower pully 23. The elongated slide hole 26 is a hole through which the base pin 25 is inserted and is formed with an area of the upper pulley 13 hollowed so as to allow the upper pulley 13 to be moved relative to the lower pulley 23. As shown in FIGS. 4A and 4B, the relative position between the lower pulley 23 and the upper pulley 13 varies depending on the size of the container 80. This causes the position, where the base pin 25 is inserted through the elongated slide hole 26, to vary depending on the size of the container 80.

The upper pulley 13 having the elongated slide hole 26 allows the base pin 25 of the lower pulley 23 to be inserted through the elongated slide hole 26. This allows the upper pulley 13 to be rotated relative to the lower pulley 23.

As shown in FIGS. 5 and 6, the base pin 25 of the lower pulley 23 (the lower base pin 25) is inserted through the elongated slide hole 26 of the upper pulley 13 and the base pin insertion hole 34a of the type change plate 34. The pulley fixing pin 15 for altering the relative position of the upper pulley 13 to the lower pulley 23 is positioned differently on the upper pulley 13 relative to the lower pulley 23, depending on the size of the container 80. As shown in FIGS. 4A and 4B, the position where the pulley fixing pin 15 is positioned on the upper pulley 13 is altered by using one of the type change plates 34 which accepts the pulley fixing pin 15 at a different position.

### Type Change Plate 34

As shown in FIGS. 5 and 3, the type change plate 34 is a part that aligns positions of three parts of a key 33 of the driving shaft 31, the pulley fixing pin 15 positioned on an upper level, and the base pin 25 positioned on a lower level. In other words, the type change plate 34 is attached to align the positions of the three parts of the key 33 of the driving shaft 31, the pulley fixing pin 15 positioned on an upper level and inserted into the upper pulley 13, and the base pin 25 positioned on a lower level and fixed to the lower pulley 23.

The type change plate 34 determines the positions of the lower pulley 23 and the upper pulley 13 based on the key 33 of the driving shaft 31, and this allows for adjusting a transfer timing of the container 80 depending on types of the upstream star wheel 91 and the downstream star wheel 92 shown in FIG. 1.

As shown in FIG. 5, the type change plate 34 has a shaft key insertion hole 340, the base pin insertion hole 34a, and the pulley fixing pin insertion hole 34b penetrating therethrough. Regardless of the size of the container 80, positions of the shaft key insertion hole 340 and the base pin insertion hole 34a of the type change plate 34 remain unchanged. The pulley fixing pin 15 is inserted through the pulley fixing pin insertion hole 34b of the type change plate 34 and inserted into the positioning hole 13a of the upper pulley 13.

As shown in FIGS. 4A and 4B, the relative position of the upper pulley 13 to the lower pulley 23 is adjusted depending on the size of the container 80, and thus the position of the pulley fixing pin insertion hole 34b of the type change plate 34 varies depending on the size of the container 80. In other words, the pulley fixing pin 15 changes the relative position of the upper pulley 13 to the lower pulley 23. In this manner, changing the relative position between the lower pulley 23 positioned on a lower level and the upper pulley 13 positioned on an upper level in FIG. 2A causes the relative position between the lower profile belt 22 wound over the lower pulley 23 and the upper profile belt 12 wound over the upper pulley 13 to be adjusted. As a result, the distance s1 (see FIG. 1) between the rear conveying element 21 provided on the lower profile belt 22 and the front conveying element 11 provided on the upper profile belt 12 is changed, to allow the containers 80 having the different diameter 80k (see FIG. 2C) to be held and conveyed.

Specifically, the type change plates 34 are prepared for each container diameter 80k (see FIG. 2C). The position where the pulley fixing pin 15 is arranged on the upper pulley 13 is set for each type change plate 34. In this manner, the type change plate 34 determines the position where the pulley fixing pin 15 is arranged on the upper pulley 13. This changes a phase (a relative position) between the upper pulley 23 and lower pulley 13 and thus changes the distance s1 between the rear conveying element 21 and the front conveying element 11 (see FIG. 1). As shown in FIG. 2B, a plurality of the containers 80 varying in the container diameter 80k (see FIG. 2C) are held between the rear conveying elements 21 and the front conveying elements 11, and conveyed from the upstream star wheel 91 to the downstream star wheel 92, from batch to batch, as indicated by an arrowed line all in FIG, 1. Attaching the type change plate 34 determines the phase between the upper pulley 13 and the lower pulley 23, which in turn determines the container 80, having the container diameter 80k, to be conveyed by the upper profile belt 12 and the lower profile belt 22.

In this structure, the center positions 80c (see FIGS. 2C and 1) of the containers 80 each held by the front conveying element 11 and the rear conveying element 21 substantially remain unchanged. This allows the present structure to be applied to another case in which the upstream star wheel 91 and the downstream star wheel 92 are replaced with different ones.

### Assembly of Upper Pulley 13, Lower Pulley 23, and Type Change Plate 34

Assembly of the upper pulley 13, the lower pulley 23, and the type change plate 34 in the above configuration are described.

As shown in FIG. 5, the driving shaft 31 is inserted through the shaft hole 230 of the lower pulley 23. The driving shaft 31, which has passed through the shaft hole 230 of the lower pulley 23, is then inserted through the shaft hole 130 of the upper pulley 13 while the base pin 25 of the lower pulley 23 through which the driving shaft 31 has passed is inserted through the elongated slide hole 26 of the upper pulley 13 (see FIG. 6). In the meantime, the base pin 25 of the lower pulley 23 is moved within the elongated slide hole 26 of the upper pulley 13 and the pulley fixing pin 15 will be inserted into the positioning hole 13a of the upper pulley 13.

Next, the pulley fixing pin 15 is inserted from above into the positioning hole 13a of the upper pulley 13. Next, as shown in FIGS. 6 and 3, the driving shaft 31 and the key 33, which have passed through the lower pulley 23 and the upper pulley 13, are inserted into the shaft key insertion hole 340 of the type change plate 34, while the base pin 25 of the lower pulley 23 is inserted through the base pin through hole 34a of the type change plate 34. The type change plate 34 is fitted onto the pulley fixing pin 15, which has been inserted into the upper pulley 13, through the pulley fixing pin insertion hole 34b. (see FIG. 3).

Next, the upper profile belt 12 is wound over the upper pulley 13 of the driving pulley 10 and the driven pulley 50. The lower profile belt 22 is wound over the lower pulley 23 of the driving pulley 10 and the driven pulley 50. This sets the distance s1 between the rear conveying element 21 provided on the lower profile belt 22 and the front conveying element 11 provided on the upper profile belt 12. As described above, the lower profile belt 22 is wound over the lower pulley 23 and the upper profile belt 12 is wound over the upper pulley 13. This determines the phase between the upper pulley 13 and the lower pulley 23, thereby determining the size of the container 80 (the container diameter 80k of the container 80) held between the rear conveying element 21 and the front conveying element 11 via the upper profile belt 12 and the lower profile belt 22.

With this structure, the container 80 is held between the rear conveying element 21 provided on the lower profile belt 22 and the front conveying element 11 provided on the upper profile belt 12, according to the container diameter 80k. The different types of type change plates 34 are prepared for the container diameters 80k of the containers 80 to be conveyed. Using the type change plate 34 according to the container diameter 80k of the container 80 requires no adjustment and allows for highly accurate positioning.

### Driven Pulley 50

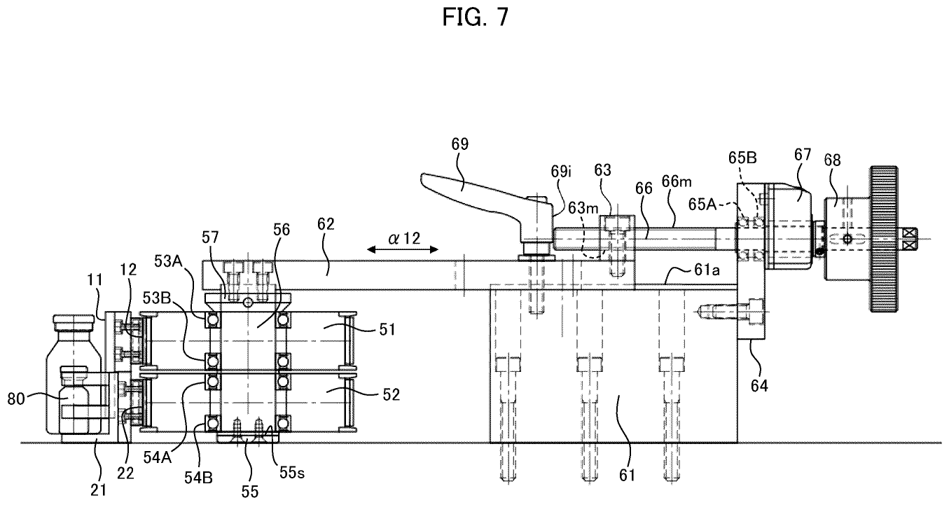

FIG. 7 is a cross-sectional view of the driven pulley 50 of the conveyor belt B, taken along a line V-V in FIG. 1. The driven pulley 50 includes a driven shaft 56 as a rotation axis. The driven shaft 56 has bearings 53A, 53B, which rotatably support an upper pulley 51, attached thereto. The driven shaft 56 also has bearings 54A, 54B, which rotatably support a lower pulley 52, attached thereto.

The upper pulley 51 is coupled with the driven shaft 56 via the bearings 53A, 53B. The lower pulley 52 is coupled with the driven shaft 56 via the bearings 54A, 54B. The lower pulley 52 and the upper pulley 51 are fixed, at a top of a combination thereof, by an annular set collar 57 as a spacer. The driven shaft 56 is contacted on a bottom thereof by a contact surface 55s of a resin part 55 and is slidable on the contact surface 55s. With this structure, the lower pulley 52 and the upper pulley 51 are held between the resin part 55 at the bottom and the set collar 57 at the top, so as to be rotated freely.

Driven Shaft Positioning Shaft 66 and Plate 62

The conveyor belt B is provided with a driven shaft positioning shaft 66 and a plate 62 to move and adjust a position of the driven shaft 56. The driven shaft positioning shaft 66 has a handle 68 fixed thereto to turn the driven shaft positioning shaft 66. The driven shaft positioning shaft 66 is threaded with a male screw 66m. Meanwhile, the plate 62 has the driven shaft 56 and a trapezoidal nut 63, as a moved member, fixed thereto.

The plate 62, to which the trapezoidal nut 63 is fixed, is guided by a guide rail 61a to slide on a base 61 (see an arrowed line α12 in FIG. 7). The driven shaft 56 is fixed to the plate 62 at the top. A female screw 63m is threaded in the trapezoidal nut 63. The male screw 66m of the shaft 66 is screwed into the female screw 63m of the trapezoidal nut 63. With this structure, when a user turns the handle 68, the male screw 66m of the shaft 66 is turned to move the trapezoidal nut 63 via the female screw 63m through which the male screw 66m is screwed. As the trapezoidal nut 63 is moved, the plate 62 is differently placed, thereby changing the position of the driven shaft 56 fixed to the plate 62.

The plate 62 is secured by a frictional force against the base 61 by tightening a lever 69. Specifically, tightening the lever 69 causes a cam 69i of the lever 69 to push and lock the driven shaft positioning shaft 66. This secures the plate 62 to the base 61 with the frictional force. Meanwhile, loosening the lever 69 unlocks the handle 68. When the handle 68 is turned in this state, the driven shaft positioning shaft 66 is turned to move the trapezoidal nut 63 along the male screw 66m of the driven shaft positioning shaft 66, thereby changing the position of the driven shaft 56 with respect to the base 61.

As being moved, the driven shaft 56 is slid, on the bottom thereof, on the contact surface 55s of the resin part 55. As the driven shaft 56 is slid, the upper pulley 51 and lower pulley 52, through which the driven shaft 56 is inserted, are moved. Having the driven shaft 56 moved allows for adjusting tensions of the upper profile belt 12 and lower profile belt 22, which are wound over the upper pulley 51 and lower pulley 52, respectively. This movement also allows the upper profile belt 12 and lower profile belt 22 to be swapped, or to be replaced with new ones. As described above, the conveyor belt B has the type change plate 34 attached according to the size of the container 80 (the container diameter 80k). As shown in FIG. 4A, changing the relative position between the upper pulley 13 and the lower pulley 23 causes the distance s1 (see FIG. 1) between the front conveying element 11 and rear conveying element 21 to be easily changed, to allow for conveying the containers 80 having any diameters.

While the conveyor belt B is in operation, a driving force of the timing pulley 42 is transmitted to the torque limiter 41, the part 40, the locking assembly 39, the driving shaft 31, the key 33 of the driving shaft 31, and the type change plate 34 in this order. The driving force is then transmitted to the base pin 25 and the pulley fixing pin 15 from the type change plate 34. This force rotates the upper pulley 13 and lower pulley 23, to synchronously drive the front conveying element 11 mounted on the upper belt 22 and the rear conveying element 12 mounted on the lower belt 12, thereby conveying the container 80 from the upstream star wheel 91 to the downstream star wheel 92.

With this structure, only adjusting the distance between the front conveying element 11 and rear conveying element 21 according to the container 80 allows for conveying the containers 80 varying in the container diameter 80k. In addition, the structure provides the conveyor belt B of the conveyor device that linearly conveys the container 80.

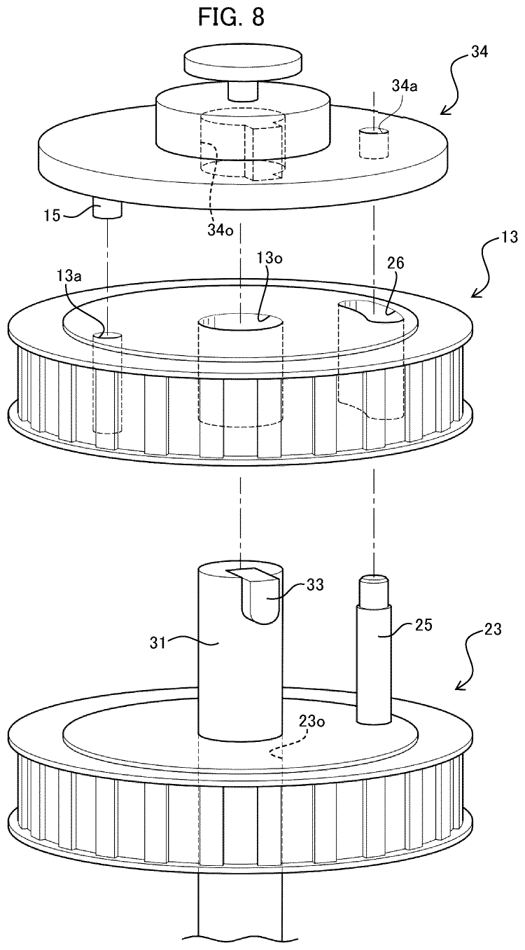

Other Embodiments
1) The embodiment described above has the rear conveying element 21 mounted to the profile belt 22 on a lower level and the front conveying element 11 mounted to the profile belt 12 on an upper level. However, the rear conveying element 21 may be mounted to the profile belt 12 on an upper level and the front conveying element 11 may be mounted to the profile belt 22 on a lower level.
2) The embodiment described above has the rear conveying element 21 and front conveying element 11 mounted to the profile belt 22 on a lower level and the profile belt 12 on an upper level, respectively. However, conveying members are not limited to the belts as long as the conveying members are in a belt-shape to which the rear conveying element 21 and front conveying element 11 are mounted.
3) The embodiment described above has shown the structure that includes the pulley fixing pin 15 separated from the type change plate 34. However, as shown in FIG. 8, the pulley fixing pin 15 can be fixed to the type change plate 34. FIG. 8 is an exploded perspective view of the upper pulley 13, the lower pulley 23, and the type change plate 34 of a modification. This structure facilitates assembling the components and reduces parts in number.
4) The present invention is not limited to the above embodiments and includes various modifications. For example, the above embodiments have been described in detail for the purpose of illustration and the present invention is not necessarily limited to a structure that includes all the configurations described above. Further, the configurations of the embodiments can be partly removed, partly replaced with other configurations, or partly added with other configurations.

### LIST OF REFERENCE SIGNS

11 front conveying element (first conveying element, upper belt conveying element)
12 profile belt (first belt body, upper belt)
13 upper pulley (first pulley, pulley)
15 pulley fixing pin
21 rear conveying element (second conveying element, lower belt conveying element)
22 profile belt (second belt body, lower belt)
23 lower pulley (second pulley, pulley)
25 base pin
31 driving shaft
34 type change plate
56 driven shaft
61a guide rail (adjustment mechanism)
62 plate (adjustment mechanism)
63 trapezoidal nut (adjustment mechanism)
68 handle (adjustment mechanism)
69 lever (adjustment mechanism)
80 container
80c center position
80k container diameter

1. A conveyor device used in manufacturing equipment to convey various types of containers, such as an ampule, varying in diameter, the conveyor device comprising:
a lower belt conveying element that supports a body on an upstream side and a bottom surface of each of the containers to be conveyed; and
an upper belt conveying element that supports the body on a downstream side of each of the containers to be conveyed,
wherein the lower belt conveying element and upper belt conveying element are respectively on a front side and a rear side of each of the containers,
wherein the lower belt conveying element and upper belt conveying element has a distance therebetween,
wherein the distance is adjusted to allow for conveying the containers varying in diameter.

2. The conveyor device according to claim 1 further comprising
pulleys over which a lower belt and an upper belt are wound respectively,
wherein the pulleys have therebetween an angle which is adjustable according to the distance for conveyance.

3. The conveyor device according to claim 2 further comprising:
a type change plate that is provided on the pulleys and configured to adjust the distance when a container having a different diameter is conveyed.

4. A conveyor device comprising:
a first conveying element and a second conveying element that hold each of containers; and
a first belt body and a second belt body on which the first and second conveying elements are provided, respectively, wherein
a relative position between the first and second belt bodies is adjustable to alter
a distance between the first conveying element and the second conveying element according to a diameter of each of the containers, and
each of the containers having the diameters is held by the first and second conveying elements and conveyed from upstream to downstream.

5. A conveyor device comprising:
a first conveying element and a second conveying element that hold each of containers;
a first belt body and a second belt body on which the first and second conveying elements are provided, respectively; and
a first pulley and a second pulley over which the first and second belt bodies are wound respectively, wherein
a relative position between the first and second pulleys is changed to adjust a relative position between the first and second belt bodies, thereby altering a distance between the first and second conveying elements according to diameters the container, and
each of the containers having the diameters is held by the first and second conveying elements and conveyed from upstream to downstream.

6. The conveyor device according to claim 1, wherein
center positions of the containers substantially remain unchanged.

7. The conveyor device according to claim 5 further comprising
a base pin and a pulley fixing pin that determine a relative position between the first and second pulleys, wherein
a position of the pulley fixing pin being fixed to the first pulley is changed to adjust the distance between the first and second conveying elements.

8. The conveyor device according to claim 7 further comprising
a type change plate through which the base pin and the pulley fixing pin are inserted, wherein
the type change plate for a different container diameter has the pulley fixing pin inserted at a different position.

9. The conveyor device according to claim 8, wherein
the type change plate having the pulley fixing pin inserted therein causes center positions of the containers to be held to substantially remain unchanged and to have the distance between the first and second conveying elements altered according to the diameter of each of the containers.

10. The conveyor device according to claim 5 further comprising:
a driving shaft that passes through the first and second pulleys;
a driven shaft that is rotated by the first and second pulleys being rotated; and
an adjustment mechanism that changes a distance between the driving and driven pulleys to adjust tensions of the first and second belt bodies.

11. The conveyor device according to claim 7 further comprising a type change plate to which the pulley fixing pin is secured.

12. The conveyor device according to claim 4, wherein
center positions of the containers substantially remain unchanged.

13. The conveyor device according to claim 5, wherein
center positions of the containers substantially remain unchanged.
